(19) United States
(12) Patent Application Publication
(10) Pub. No.: US 2011/0228846 A1
(43) Pub. Date: Sep. 22, 2011

(54) Region of Interest Tracking and Integration Into a Video Codec

(76) Inventors: Eran Eilat, Beit Shean (IL); Dagan Eshar, Jerusalem (IL); Gershom Kutliroff, Alon Shvut (IL); Shai Shimon Yagur, Tel Aviv (IL)

(21) Appl. No.: 12/886,206

(22) Filed: Sep. 20, 2010

Related U.S. Application Data
(63) Continuation of application No. 12/697,812, filed on Feb. 1, 2010, now abandoned.
Application No. 12/697,812 is a continuation of application No. 11/991,025, now abandoned.

(51) Int. Cl. H04N 7/26

(52) U.S. Cl. 375/240.08; 375/E07.2

(57) ABSTRACT

There is provided a system for tracking a region of interest in a video includes an identifier for identifying the region of interest and determining a location of the region of interest in a first frame of a video sequence, and a tracker for locating the region of interest in at least a second frame, based on a location of the region of interest in the first frame. The system also includes a recovery manager for determining whether the tracker has correctly located the region of interest. There is also provided a method for tracking a region of interest in a video.

### CROSS-REFERENCE TO RELATED APPLICATIONS

This application is a continuation of U.S. patent application Ser. No. 12/697,812, filed on Feb. 1, 2010, which is a continuation of U.S. patent application Ser. No. 11/991,025, filed on Feb. 26, 2008, which claims priority in PCT/US2006/026619 filed on Jul. 7, 2006, and U.S. Provisional Patent Application No. 60/711,772, filed on Aug. 26, 2005, under 35 U.S.C. §119(e) and 35 U.S.C. §365, the disclosures of which are incorporated in its entirety by reference herein.

### BACKGROUND OF THE INVENTION

1. Field of the Invention

The present invention relates to video coding and compression, and more particularly, to detecting, tracking, coding and compressing “regions of interest” of images in a video.

2. Description of the Related Art

Each image, or “frame”, of a video sequence is composed of a fixed two dimensional array of pixels (for example, 320×240). For grayscale images, pixels are represented by integer intensity values ranging from 0 to 255. For color images, each pixel is represented by three intensity values (for example, one each for red, green and blue). A macroblock is a two dimensional array of pixel values, corresponding to a (contiguous) subset of the image. In order to compress a frame of a video sequence, a video encoder first partitions each frame into macroblocks of varying sizes, typically of size 16×16, 8×8, or 4×4 pixels. In a general sense, the video encoder compresses the data by specifying the pixel values of each macroblock in an efficient manner, thus yielding an encoded bitstream. The encoded bitstream is transmitted to a decoder, where the pixel values are reconstructed. However, there are many different modes by which pixel values can be specified by the encoder. The pixel values for each macroblock can be predicted from previous or successive video frames, or from the pixel values of other macroblocks in the same video frame. If the prediction from a macroblock is not exact, the difference between two macroblocks can be computed by subtracting the pixel values of one macroblock from the other, and this difference can then be transmitted to the decoder. Alternatively, if there is no other macroblock that sufficiently approximates the macroblock of interest, the pixel values of the macroblock can be explicitly specified and transmitted to the decoder. In the following, it is assumed, without loss of generality, that the values of a macroblock either represent the pixel values of the original image for this macroblock, or the difference between the pixel values of two macroblocks.

Lossy video codecs are generally preferred in video compression. Lossy compression yields significant gains in bitrate over lossless compression, and in exchange tolerates a certain amount of error in the reconstruction of the video frames at the decoder. With lossy compression, some of the information in a given frame is discarded. In order to decide which information is less “significant” (that is, less noticeable to the human eye) and can therefore be discarded, the encoder applies a transformation to each macroblock. In the transform space, less significant information can be filtered out. A typical choice of transform is the Discrete Cosine Transform (DCT). Alternatively, a wavelet transform can be used. After a macroblock is transformed with the DCT, the values of the DCT coefficients are “quantized”. Quantization is a process by which each coefficient value is divided by a fixed number q, and the remainder is discarded. At the decoder side, this quantized DCT coefficient will be multiplied by the same preset q value. Effectively, this method yields an approximation to the original pixel value. In order to control how much the transform coefficients are quantized, each macroblock in a video frame has a quantization parameter (“QP”) value associated with it. On a per-macroblock basis, the values q used to quantize the coefficients are multiplied by QP before the coefficients are quantized. In this way, the values of QP for the macroblocks of a given video frame determine the accuracy of the approximation of this image, and consequently, the size of the compressed bitstream. Naturally, there is an inverse relationship between the approximation error and the size of the compressed bitstream: the larger the error, the smaller the bitstream.

Real-time applications using a fixed bandwidth, such as a videophone, require that the size of the bitstream remains within the throughput capacity of the available bandwidth. In the case of a videophone over the PSTN (Public Switched Telephone Network), for example, one may want to ensure that the bitstream for the video remains under 20 Kbits (kilobits per second). As discussed above, the quality of each frame is determined by the values of QP for all the macroblocks of the frame. The quality of the video as a whole also depends on its frame rate, that is, the number of frames per second. Video encoders contain a rate-control mechanism which adjusts these parameters—the values of QP for each video frame and the frame rate of the overall video sequence—in order to ensure that the total bitstream generated by the encoder remains within the targeted bandwidth.

Often, a specific region of the video holds particular interest to the viewer, and the user prefers to obtain this region of interest at a higher quality, even at the expense of the rest of the video. There exists a need for a method of video compression that tracks and compresses a region of interest throughout a video sequence.

### SUMMARY OF THE INVENTION

A method and system for video processing and encoding is provided. The method includes determining a location of a first region in a first frame of a video sequence, and locating the first region in a second frame of the video sequence, wherein the second video frame occurs subsequent to the first video frame. The first region may be an image of a face.

A system for tracking a region of interest in a video includes an identifier for identifying the region of interest and determining a location of the region of interest in a first frame of a video sequence, and a tracker for locating the region of interest in at least a second frame, based on a location of the region of interest in the first frame. The system also includes a recovery manager for determining whether the tracker has correctly located the region of interest.

In one embodiment, the recovery manager determines whether the tracker has correctly located the region of interest by comparing characteristics of a region located by the tracker in the second frame to pre-selected characteristics of the region of interest identified in the first frame. The recovery manager re-applies the identifier to the second frame if the characteristics do not match the pre-selected characteristics within a selected tolerance.

In another embodiment of the system, the region of interest may be one or more faces. The region of interest may also be a plurality of independent regions of interest.

There is also provided another embodiment of a system for tracking a region of interest in a video. The system includes a recovery manager for determining when to apply i) an identifier for identifying the region of interest and determining a location of the region of interest in a first frame of a sequence of frames in a video sequence, and ii) a tracker for taking into account a location of the region of interest in the first frame and locating the region of interest in a second frame.

In one embodiment, the recovery manager determines when to apply the identifier and the tracker by comparing a region located by the tracker in a selected frame by comparing characteristics of a region located by the tracker in the second frame to pre-selected characteristics of the region of interest identified in the first frame. The recovery manager may direct the system to re-apply the identifier to the selected frame if the characteristics do not match the pre-selected characteristics within a selected tolerance.

In another embodiment, the identifier calculates a color probability distribution that takes into account the probability of a pixel having the same color as a color found in the region of interest. The color probability distribution is a probability density function that represents the probability that a color appears in the region of interest. The tracker may determine a location of the region of interest based on the color probability distribution.

In yet another embodiment, the system further includes a calculator that calculates a first quantization level for the region of interest, and calculates a second quantization level for a second region of the image in the video sequence, and a compressor that produces a compressed bitstream having the first level of quantization for the region of interest, and the second level of quantization for the second region. The calculator may calculate the first and second levels of quantization so that the compressed bitstream has a bitrate of less than a target value.

There is also provided another embodiment of a method for tracking a region of interest in a video. The method includes identifying the region of interest and determining a location of the region of interest in a first frame of a video sequence, locating the region of interest in at least a second frame, based on a location of the region of interest in the first frame, and determining whether the tracker has correctly located the region of interest.

In one embodiment, the step of determining includes periodically comparing selected characteristics of the first region with pre-selected characteristics to determine whether the tracker is correctly tracking the first region. The method may further include repeating the steps of identifying and locating the region of interest if the characteristics do not match the pre-selected characteristics within a selected tolerance. The region of interest may be an image of one or more faces.

In one embodiment, the method further includes dividing the image into a plurality of macroblocks, determining whether each macroblock of the plurality of macroblocks falls in at least a portion of the first region, and compressing each macroblock into a bitstream having a size depending on a desired video quality of uncompressed video of the macroblock. Each macroblock has a video quality based on whether the macroblock at least partially falls in the first region.

Each macroblock may be a macroblock falling entirely in the first region, a macroblock falling partially in the first region, or a macroblock falling entirely in a region other than the first region. The image quality may be highest for the macroblock falling entirely in the region of interest, and lowest for the macroblock falling entirely in a region other than the region of interest. In another embodiment, macroblocks falling entirely in a region other than the first region are excluded from the transmission.

The method may further include monitoring a total number of bits produced by the compression of the plurality of macroblocks, and comparing the total number of bits to a pre-selected maximum number of bits. In another embodiment, the method further includes periodically comparing selected characteristics of the first region with pre-selected characteristics to determine whether the tracker is correctly tracking the first region.

In yet another embodiment, there is provided a method for extracting a subset of an image from a video sequence, and displaying the subset of the image. The subset may include a face of a user. The subset may also include a feature that changes position in the image between a first frame of the video sequence and a second frame of the video sequence.

### BRIEF DESCRIPTION OF THE DRAWINGS

FIG. 100 is a diagram illustrating the movement of a head-and-shoulders figure through three consecutive frames of a video sequence.

FIG. 200 is a flowchart of an encoder utilizing a codec that incorporates the region of interest tracking mechanism.

FIG. 300 is a flowchart of an algorithm for detection of the initial location of a region of interest, such as a face, in a video sequence.

FIG. 400 is a flowchart of an algorithm for tracking the region of interest frame by frame.

FIG. 500 is a diagram of an apparatus using the method of the invention in a one-way videophone.

### DESCRIPTION OF THE INVENTION

There is provided a method for tracking a region of interest, i.e., a specific region of a video that is of a particular interest to a user, throughout the video sequence and, after the region of interest has been located in a particular frame, generating appropriate values of a quantization parameter, hereinafter “QP”, to be integrated into a video codec's rate-control mechanism. The values of QP are dependent on the location of each macroblock vis-à-vis the region of interest. In an exemplary embodiment, the method is used in conjunction with a videophone application over a public switched telephone network, hereinafter “PSTN”. In a PSTN, for example, there is generally an available bandwidth of about 28 Kbits, of which 8 Kbits must be reserved for audio. This leaves 20 Kbits for video. At such low bitrates, the only way to achieve “continuous” video, i.e., at least 12-15 frames/second, is to sacrifice on the quality of each frame. However, the typical use of a videophone is for a dialogue between two individuals. In this case, each user is more interested in seeing the other user's face than the rest of the image, and therefore the image of a user's face would be considered the region of interest.

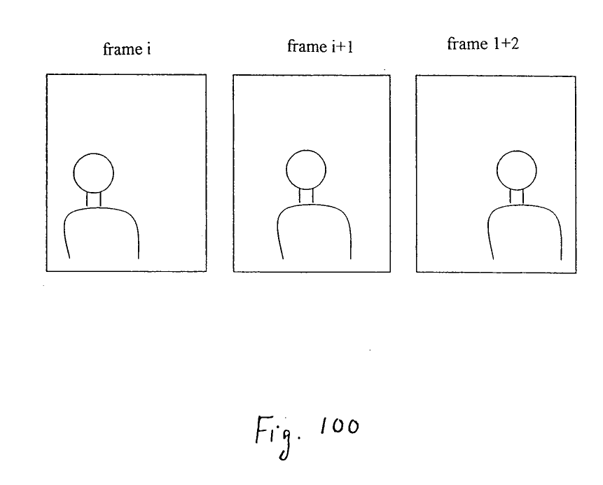

FIG. 100 is a diagram illustrating the movement of a head-and-shoulders figure through three consecutive frames of a video sequence. The first frame is provided as “frame i”, the second consecutive frame is “frame i+1”, and the third consecutive frame is “frame i+2”. The location of the region of interest may be any designated region of the image. In the present embodiment, the region of interest is the head or face of the figure. The region of interest may also be both the head and shoulders of the figure. A tracking algorithm is provided to track the location of the region of interest. The objective of the tracking algorithm is to identify the locations of this region of interest in all frames of the video.

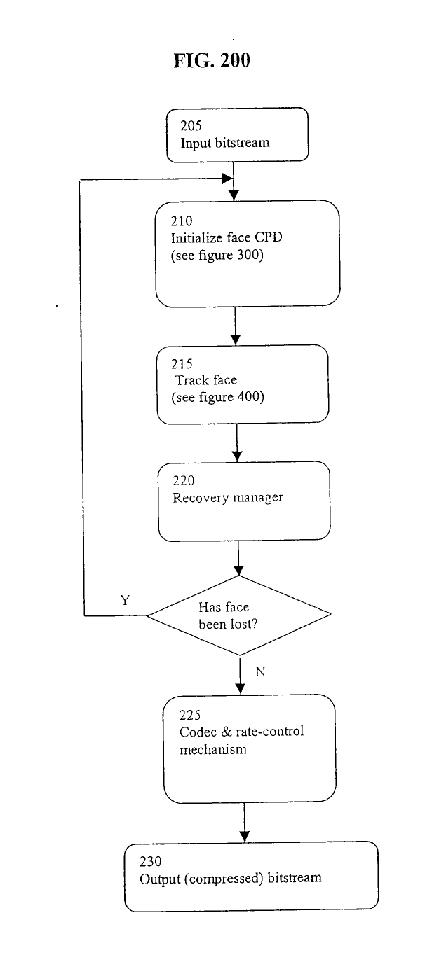

FIG. 200 is a flowchart of an encoder utilizing a codec that incorporates the region of interest tracking mechanism. The codec encodes the video images into a compressed bitstream.

At step 205, the system receives an input bitstream from a source. In the preferred embodiment, this bitstream represents video captured by a camera and the video contains the head and shoulders of a subject. The bitstream must then be compressed so it can be transmitted over a network. In order to display the region of interest at a higher quality, the location of this region must be tracked throughout the sequence. A color probability distribution, hereinafter “CPD”, is used to track the region. A CPD is a single-valued probability density function that represents the probability that a particular color appears in the region of interest. In particular, given a pixel in an image, the CPD returns the probability that the pixel's color is found on the region of interest. The CPD is used as follows.

Given an image, a new image can be constructed by replacing each pixel in the image by the value returned by the CPD for this pixel's color. This new image is called a Color Probability Image (CPI). Consequently, the value of a pixel in a CPI represents the likelihood that the corresponding pixel in the original image has the same color value as the region of interest. In the embodiment of a videophone where the location of a face is tracked, a region of the CPI with a patch of high intensity values indicates a likely position of the face in the original image.

At step 210, the region of interest is detected initially in a video sequence, and a CPD for this region is constructed. In the case of the embodiment of a videophone, a method for initially detecting the location of the face is described in diagram 300, and below.

Any color can be expressed by a linear combination of the three colors red, green and blue, where the amount of each of red, green and blue is represented by an integer value between 0 and 255. This is known as representing colors in the “RGB color space”. Any color can also be expressed in the YUV color space, with values for “Y” (or “luminance”), “U” (or “chrominance A”) and “V” (or “chrominance B”). The YUV and RGB color spaces are related via a linear transformation, so it is easy to go back and forth between these two representations. In one embodiment, a CPD can take the form of a 2-dimensional empirical histogram, representing the color as the corresponding values of U and V (the second and third dimensions, respectively, of YUV color space).

Once the region of interest is found initially, this region is sampled and a 2d-histogram is constructed from it as follows. The sampled color values are binned, and the number of values in each bin is summed. Each of these sums of the bins is then divided by the total number of samples, to yield the empirical probability that any pixel's color value corresponding to this bin appears in the region of interest. Once a region of interest's CPD is initialized, the next step is to track this region throughout the video sequence.

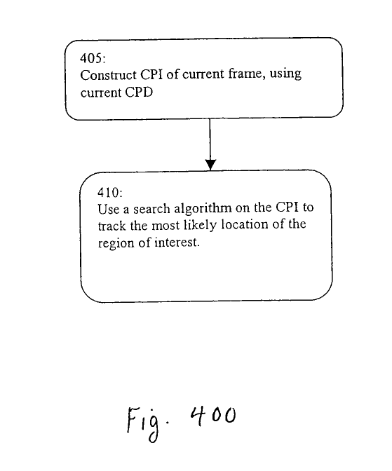

At step 215, the region of interest is tracked throughout the video sequence. The technique to track the ROI is illustrated in FIG. 400 and described below.

The results of the tracking algorithm are passed on to the recovery manager, illustrated at step 220. The recovery manager at step 220 operates independently of the tracking algorithm described in FIG. 400 and evaluates whether the region of interest has indeed been located. The recovery manager's evaluation is executed once every several frames. The frequency of this evaluation varies, and depends on how much time the evaluation requires. In a sample implementation of the embodiment of a videophone application, for example, the recovery manager checks for ranges of attributes or characteristics of a candidate's face. For example, the recovery manager may check that a candidate face is neither too large nor too small, and that the ratio of the height of the candidate face to its width falls within a fixed, preset range. If the recovery manager determines that the face has indeed been lost, the algorithm returns to step 210 and the face CPD is reinitialized, preferably from the frame on which the recovery manager was applied. Otherwise, the results of the tracking algorithm are passed on to step 225, where they are integrated into a video codec.

At step 225, the integration into a video encoder is performed as follows. Three types of macroblocks are identified, namely (1) those that fall entirely on the region of interest, (2) those that fall partially on the region of interest and partially on the background, and (3) those that fall entirely on the background. For these three macroblock types, three distinct values of QP are used. QP values vary based on the type of macroblock identified.

In one embodiment, the lowest QP values are assigned to macroblocks of type (1), i.e., falling entirely on the region of interest. Lower QP values result in smaller errors in image approximation, and thus a larger bitstream and higher image quality for that macroblock. For macroblocks of type (2), i.e., falling partially on the region of interest, a higher QP value is assigned, corresponding to higher errors in the image but a smaller bitstream. Lastly, for macroblocks of type (3), i.e., falling entirely on the background, the highest QP value is assigned, corresponding to the highest errors and lowest quality image, and also corresponding to the smallest bitstream.

As the encoder processes the frame macroblock by macroblock, the current number of bits used for the frame thus far vis-à-vis the entire bit budget for the frame is monitored. If the number of bits necessary to represent this frame goes over the frame's bit budget, the three QP values are adjusted on an ad-hoc basis to ensure that the size of the bitstream remains within the desired budget.

At step 230, the compressed bitstream is transmitted over a network to a standard video decoder, where the video can be reconstructed.

An alternate embodiment of the method displays only the region of interest, and filters out the remainder of each video frame entirely. In this “focus mode”, only the macroblocks falling within a rectangular box that bounds the region of interest are displayed. All remaining macroblocks are skipped, i.e., not transmitted. There are two options for displaying the region of interest in focus mode. The first maintains the original size of the image and paints the regions outside the region of interest black. Alternatively, the second display option expands the region containing the region of interest to use the entire image size. Because in focus mode all of the available bandwidth is used only for the region of interest, this region is displayed at much higher resolution than in standard mode.

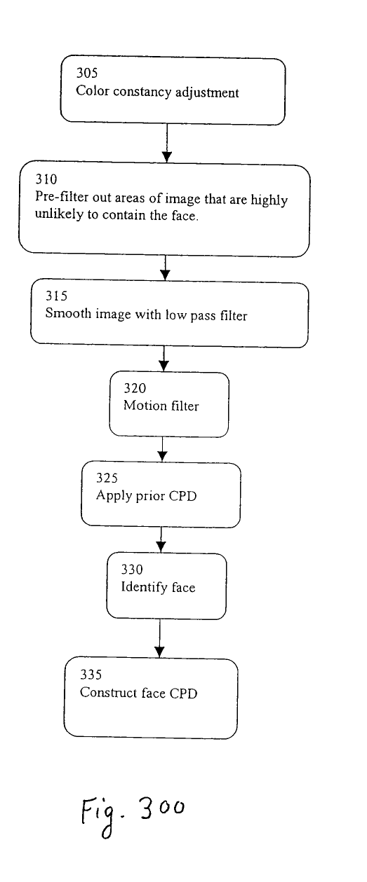

FIG. 300 illustrates an algorithm to detect the initial location of a face in a video sequence. This algorithm may be utilized in the encoding method described above, for example, in step 210 of FIG. 200.

At step 305, a Modified-Gray-World algorithm is run on the input image, in order to reduce the influence of ambient illumination.

At step 310, the algorithm filters out areas of an image that are highly unlikely to contain a face by removing areas where a face is unlikely to appear, based on patterns of intensity. Regions are dealt with on a case-by-case basis. For example, regions that are either “too noisy” (that is, contain very high-frequency data) or have very high color saturation are filtered out at this step. Cameras introduce noise into an image. This noise can degrade the results of the motion filter at step 320.

At step 315, a low-pass filter is applied to each image in order to effectively filter out this noise.

At step 320, a filter is applied to N successive frames of a video sequence in order to filter out areas where no motion is detected. For each video frame being monitored, a difference image is constructed by taking the difference between all the pixel values of two successive frames. On this difference image, an edge-detection algorithm is applied to pick up regions of the image where there is movement between successive frames. After the motion is tracked in this way for N frames, a value, “mᵢ(x,y)”, is calculated for each pixel, representing the amount of motion detected at each pixel of the image. Weights, represented by “wᵢ”, are then applied based on the proximity of previous frames to the current frame. Thus,

Relative motion at pixel (x,y)=w_{N}*(w_{N-1}* . . . *(w₂*(w₁*m₁(x,y))+m₂(x,y))+m_{N-1}(x,y))+m_{N}(x,y)

If the relative motion is below a selected motion detection threshold, pixels in this region are ignored (filtered out). In addition, this threshold is dynamic. If too many pixels pass the threshold or too many pixels fall below the threshold, the threshold is adapted accordingly.

At step 325, a CPI of the current frame is constructed using a prior CPD. This prior CPD is constructed from training data containing many images in which the location of the face is hand-marked. The prior CPD, applied directly to the original image, is a decent first estimate, but does not, in general, reliably locate the face.

At step 330, the face detection algorithm finds the region of the image containing the face. Recall that the color probability image (CPI) is constructed by replacing each pixel in an image with the probability value that this color appears on the face. The exact location of the face is then obtained by calculating the horizontal and vertical projections of the CPI, in the following manner. Assume an image has N rows and M columns. The image's intensity values at a pixel of row x and column y are represented as I(x,y). Then, the vertical projection is defined as Σ_{x=1 . . . N}I(x,y). Similarly, the horizontal projection is defined as Σ_{y=1 . . . M}I(x,y). In order to precisely pinpoint the location of the face, a vertical projection is first constructed from the entire CPI. This one-dimensional projection is then progressively scanned for a pair of local minimums or local maximums. The horizontal boundaries of the area of the image corresponding to the region that lies between these two local extrema are marked as the horizontal boundaries of the face. We now effectively discard the area of the image that does not correspond to the region between the local extrema of the vertical projection and consider only the strip that does correspond to this region. Subsequently, the horizontal projection of this strip of the image is calculated. Again, the one-dimensional (this time horizontal) projection is scanned for local extrema. The region that lies between the local extrema corresponds to the vertical boundaries of the face in the original image. In this way, the precise location of a face in an image is found.

At step 335, a 2-dimensional CPD is constructed specifically for each video sequence. After the face is located by the previous steps, it is sampled in order to construct a new CPD to be used to track the face either throughout the video or until it is updated at the behest of the Recovery Manager at step 220.

FIG. 400 is a flowchart of the algorithm to track the region of interest frame by frame.

At step 405, a CPI of the current frame is constructed, as follows. Using the CPD, each pixel of the current frame is replaced with the value returned by the CPD for the pixel's color.

At step 410, starting from the location of the face in the previous frame, a search algorithm is used in order to locate a rectangular window on the area in the CPI most likely to correspond to the region of interest in the original video image.

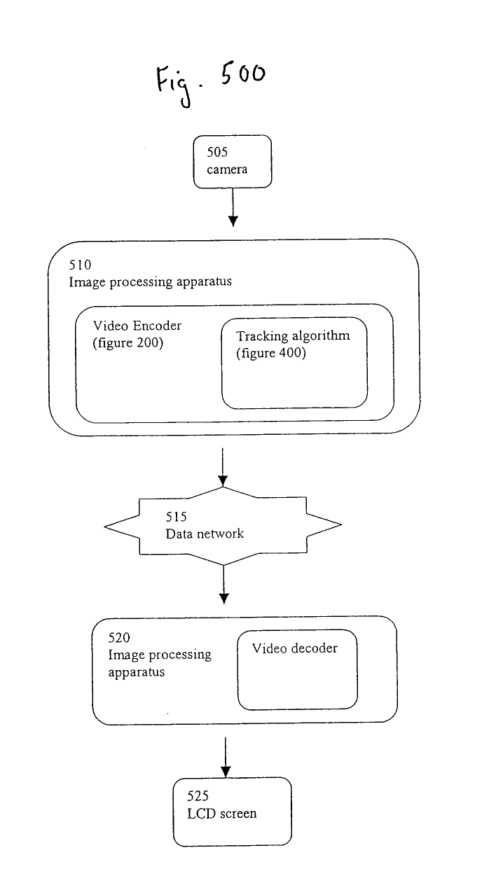

FIG. 500 illustrates a sample apparatus employing the method described above for detecting and tracking a region of interest. This sample apparatus is a one-way videophone. The system includes a video camera 505, an image processing apparatus 510, a data network 515, an image processing apparatus 520, and a liquid crystal display (LCD) screen 525.

Video camera 505 acquires input video images. Successive frames of the video are streamed to image processing apparatus 510.

Image processing apparatus 510 compresses the video stream (as illustrated in FIG. 200), applies the face detection algorithm (as illustrated in FIG. 300) to the first several frames that are received from video camera 505, and constructs a CPD. For successive frames, image processing apparatus 510 applies the tracking algorithm (as described in FIG. 400) to locate the region of the face. As described in FIG. 200, if the recovery manager determines that the face has been lost, the CPD is reinitialized as in FIG. 300. After the location of the face is identified, the compressed bitstream is generated by the encoder in image processing apparatus 510. Image processing apparatus 510 transmits the compressed bitstream to data network 515.

Data network 515 can be any suitable data network, e.g., a PSTN network. Data network 515 receives the compressed bitstream from image processing apparatus 510, and forwards the compressed bitstream to image processing apparatus 520.

Image processing apparatus 520 receives the compressed bitstream from data network 515. Image processing apparatus 520 includes a standard video decoder that decodes the compressed bitstream. Image processing apparatus 520 then reconstructs a standard video sequence, and forwards the standard video sequence to LCD screen 525.

LCD screen 525 displays the standard video sequence. Screen 525 need not be an LCD screen, but may be any suitable display device.

Operations of video camera 505, image processing apparatus 510, data network 515, image processing apparatus 520, and liquid crystal display (LCD) screen 525, as described herein, may be implemented in any of hardware, firmware, software, or a combination thereof. When implemented in software, they may also be configured as a module of instructions, or as a hierarchy of such modules, and stored in a memory, e.g. an electronic storage device such as a random access memory, for controlling a processor, e.g., a computer processor. The instructions can also reside on a storage media, such as, but not limited to, a floppy disk, a compact disk, a magnetic tape, a read only memory, or an optical storage media.

It should be understood that various alternatives, combinations and modifications of the teachings described herein could be devised by those skilled in the art. The present invention is intended to embrace all such alternatives, modifications and variances that fall within the scope of the appended claims.

What is claimed is:

1. A system for tracking a region of interest in a video, comprising:
an identifier for identifying said region of interest and determining a location of said region of interest in a first frame of a video sequence;
a tracker for locating said region of interest in at least a second frame, based on a location of said region of interest in said first frame;
a recovery manager for determining whether said tracker has correctly located said region of interest;
a calculator that calculates a first quantization level for said region of interest, and calculates a second quantization level for a second region of an image in said video sequence; and
a compressor that produces a compressed bitstream having said first level of quantization for said region of interest, and said second level of quantization for said second region.

2. The system of claim 1, wherein said recovery manager determines whether said tracker has correctly located said region of interest by comparing characteristics of a region located by said tracker in said second frame to pre-selected characteristics of said region of interest identified in said first frame, and wherein said recovery manager re-applies said identifier to said second frame if said characteristics do not match said pre-selected characteristics within a selected tolerance.

3. The system of claim 1, wherein said region of interest is one or more faces.

4. The system of claim 1, wherein said region of interest is a plurality of independent regions of interest.

5. The system of claim 1, wherein said recovery manager determines when to apply said identifier and said tracker by comparing a region located by said tracker in a selected frame by comparing characteristics of a region located by said tracker in said second frame to pre-selected characteristics of said region of interest identified in said first frame.

6. The system of claim 5, wherein said recovery manager directs said system to re-apply said identifier to said selected frame if said characteristics do not match said pre-selected characteristics within a selected tolerance.

7. The system of claim 1, wherein said identifier calculates a color probability distribution that takes into account the probability of a pixel having the same color as a color found in said region of interest.

8. The system of claim 7, wherein said color probability distribution is a probability density function that represents the probability that a color appears in the region of interest.

9. The system of claim 7, wherein said tracker determines a location of said region of interest based on said color probability distribution.

10. The system of claim 1, wherein said calculator calculates said first and second levels of quantization so that said compressed bitstream has a bitrate of less than a target value.

11. A method for tracking a region of interest in a video, comprising:
identifying said region of interest and determining a location of said region of interest in a first frame of a video sequence;
attempting to locate said region of interest in at least a second frame, based on a location of said region of interest in said first frame;
determining whether said attempting has correctly located said region of interest, and if so, then:
dividing said image into a plurality of macroblocks;
determining whether each macroblock of said plurality of macroblocks falls in at least a portion of said region of interest; and
compressing each said macroblock into a bitstream having a size depending on a desired video quality of uncompressed video of said macroblock, wherein each said macroblock has a video quality based on whether said macroblock falls in said portion.

12. The method of claim 11, wherein said step of determining includes periodically comparing selected characteristics of said region of interest with pre-selected characteristics to determine whether said attempting is correctly tracking said first region.

13. The method of claim 12, further comprising repeating the steps of identifying and locating said region of interest if said characteristics do not match said pre-selected characteristics within a selected tolerance.

14. The method of claim 11, wherein said region of interest is an image of one or more faces.

15. The method of claim 11, wherein said video quality is highest for said macroblock falling entirely in said region of interest, and said video quality is lowest for said macroblock falling entirely in a region other than said region of interest.

16. The system of claim 1, wherein said second quantization level is based on a location of said second region relative to a location of said region of interest.
